(19) United States
(12) Patent Application Publication
(10) Pub. No.: US 2004/0217079 A1
(43) Pub. Date: Nov. 4, 2004

(54) Boom clutch

(76) Inventor: David J. Higgins, Calhoun, GA (US)

Correspondence Address: DAVID J. HIGGINS, 1706 RED BUD RD., CALHOUN, GA, 30701, US

(21) Appl. No.: 10/428,672

(22) Filed: May 2, 2003

(51) Int. Cl. B66C 23/82

(52) U.S. Cl. 212/298

(57) ABSTRACT

A crane, with a pendant supported boom rotating in a vertical plane, the pendants operable to rotate said boom by a mast rotating in a vertical plane, means to rotate the mast, and said means to rotate operable to restrain the mast from counter rotation; wherein the improvement being a clutch releaseably coupling said mast to said boom, said clutch operable to restrain rotation of said boom in either direction in the absence of rotation of said mast.

### CROSS-REFERENCE TO RELATED APPLICATIONS

U.S. Patent Application # 60/374,967 (Provisional)

U.S. Patent Application #60/192,518 (Provisional)

U.S. patent application Ser. No. 10/094,443

US Patent Application #60/268,182

U.S. Pat. No. 6,481,587

U.S. Pat. No. 6,062,405

### STATEMENT REGARDING FEDERALLY SPONSORED RESEARCH OR DEVELOPMENT

Not Applicable

### REFERENCE TO A MICROFICHE APPENDIX

Not Applicable

### BACKGROUND OF THE INVENTION

This invention is particularly effective on lifting cranes with pendant supported booms and a live mast luffed by a push-pull actuator such as a hydraulic cylinder. U.S. Pat. No. 6,062,405 and U.S. Pat. No. 6,481,587 show cranes of this type.

Current art pendant supported, live mast luffed booms require a system to act as a boom restraint. The boom restraint system prevents the boom from overluffing or booming up too far. Overluffing can occur by excessive control input, wind load, or sudden release of stress in the boom/pendant system when a load is rapidly decreased. The boom restraint system normally includes a pair of carefully calibrated gas charged shock absorbers connected from the boom to the superstructure and a compressed gas reservoir with associated plumbing.

Live mast luffed booms also require a system for supporting and luffing the boom in a shortened condition for self-assembly duties. Before the boom length is set and the pendant forestay extended for normal lifting duties, a set of rigging pendants is typically temporarily installed from mast tip to the tip of the base boom section. This system is installed manually and removed prior to completion of assembly.

Live mast booms also require the setting of the mast to boom angle. It is advantageous to set the mast nearly perpendicular to the boom except that at higher boom angles the tail swing of the machine is increased. A compromise requires an increase in the boom system stress or an increase in tail swing. Adjusting the angle of a typical mast with respect to the boom is currently normally accomplished manually by lowering the boom tip to blocking placed on the ground.

Still another characteristic of cranes of this type is the ability to fold down and closely nest the boom, mast, luffing cylinders for road travel. Closely aligning components in this manner causes an unfavorable geometry of the pivot pins which connect the components to the frame and the actuator. As the pins line up the linear force provided by the actuator ceases to convert to the rotational force required to raise these components into working position.

### OBJECT OF THE INVENTION

The present invention obviates the need for some of the components of current art cranes and also performs some functions unavailable on current art cranes. Specifically, the present invention eliminates the need for the boom restraint system, the rigging pendant system, and the assist cylinder required to raise some masts from transport position. The present invention also facilitates boom and pendant length changes without the need to rest the boom on the ground.

It is an object of this invention to; furnish full positive control of the boom angle on pendant supported booms; to allow limited lifting duties from the shortened boom without pendant support; to allow simplified adjustability of the mast to boom angle for worksites where tailswing is limited; to positively and automatically support the boom against wind, inertia and gravitational loads during extension/retraction of the boom and during normal lifting duties; to facilitate close nesting of components for road travel; to allow nesting of components at negative relative angles.

### BRIEF SUMMARY OF THE INVENTION

The present invention is a releasable mast-to-boom clutch designed to positively couple the rotation of the mast to the rotation of the boom. In a preferred embodiment of the invention the boom is fitted near its base with a pair of hydraulic cylinders connecting near the base of the mast. These cylinders furnish overluff protection, engage the base boom section to luff it via the live mast in the absence of a forestay, allow pushbutton adjustability of the mast/boom angle, and furnish independent force to raise the mast from a nested position beside or below the boom.

### DETAILED DESCRIPTION OF THE INVENTION

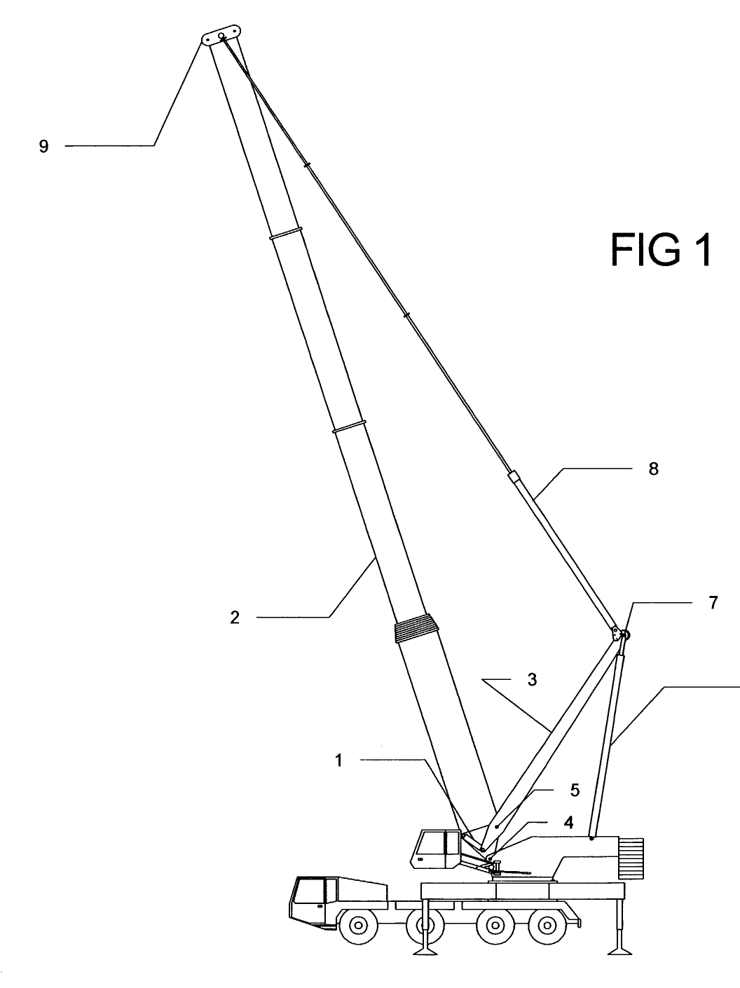

In one preferred embodiment of the invention the boom clutch includes hydraulic cylinder 1, shown in FIG. 1, and valves wiring and switches, not shown. Hydraulic cylinder 1 is a typical hydraulic cylinder in that it features a piston side oil chamber and a rod side oil chamber with ports allowing oil to flow to or from either chamber. Oil flow is controlled by electro-hydraulic solenoid valves with switches at the operator's control cab. The operator or computer can activate controls to add to, pressurize, drain or hold the oil in the cylinder chambers.

Cylinder 1 is attached pivotally on the piston side to boom 2 and pivotally on the rod side to mast 3. Boom 2 and mast 3 rotate in a vertical plane about boom foot pin 4 and mast hinge pin 5 respectively. It is preferred that pin 4 be parallel to pin 5. Mast hinge pin 5 connects mast 3 to boom 2 at a suitable perpendicular distance from cylinder 1 so as to afford sufficient moment arm through the range of motion of cylinder 1.

Boom hoist cylinder 6 is actuated to rotate mast 3 about pin 5, moving mast tip 7 in an arc, forcibly pulling pendant 8. Pendant 8, being a tensile member, pulls boom tip 9 in a complimentary arc causing boom 2 to rotate about foot pin 4. The rotational force obtainable furnishes the load lifting power of the crane. Pendant 8 is a tensile member and does not keep the boom from overluffing, for example: blowing over, falling over, or springing back from a suddenly released load. Hydraulic cylinder 1 furnishes the required resistance to overluffing. During normal lifting duties the ports on cylinder 1 are closed to oil flow—thus keeping the hydraulic cylinder 1 locked at the extension shown—securely engaging mast 3 with boom 2. Just like on any clutch, the two clutched components, in this case, the mast and the boom, rotate together when the clutch is engaged. In this embodiment the clutch is engaged by blocking the oil flow into or out of either chamber of hydraulic cylinder 1.

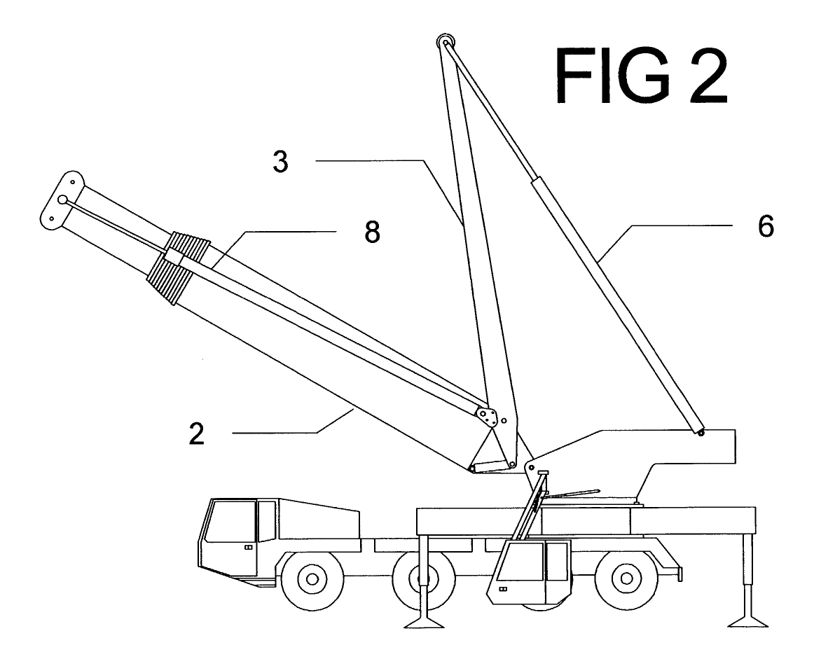

Referring to FIG. 2, the same crane is broken down into self-assembly mode. Pendant 8 no longer supports the shortened boom 2. Control of the rotation of boom 2 is still required for moderate lifting and self-assembly duties. Cylinder 1 remains engaged and transfers appropriate forces from boom 2 to mast 3 which is still controlled by boom hoist cylinder 6.

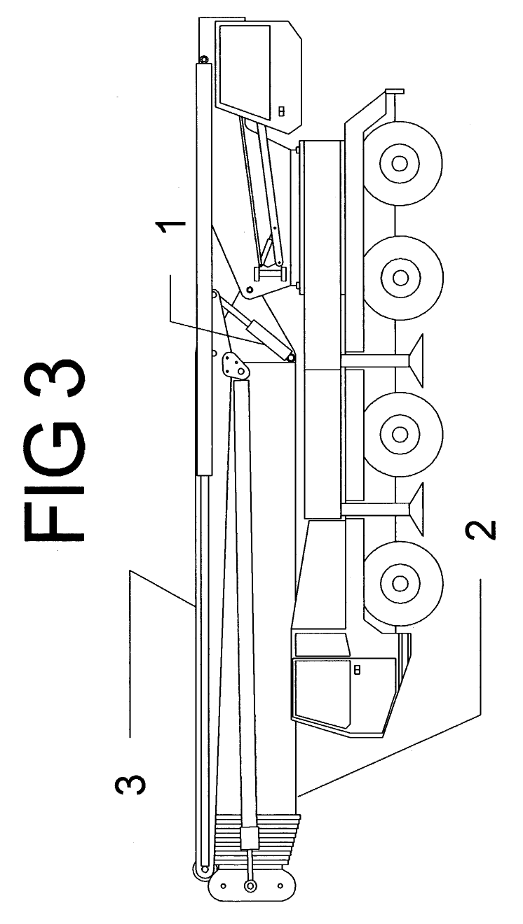

In FIG. 3, cylinder 1 has been released, allowing mast 3 to fold nestably with boom 2 for compact storage. In a configuration where the geometry of the hinge pins prevents Cylinder 6 from exerting appropriate force to raise mast 3 from the stowed position in FIG. 3, pressure is introduced into the rod side of cylinder 1 causing mast 3 to pivot up with respect to boom 2. In accordance with the present in invention—all three crane modes— stowed travel mode, self-assembly mode, lifting duty mode can be obtained by the operator by the flick of a switch or hydraulic control valve—simply controlling the oil flow to or from the respective chambers of cylinder 1.

Other embodiments of the present invention are contemplated. The present invention can be readily adapted by those skilled in the art to a wide variety of lifting, reaching, and support type applications. Crane manufacturers, utilizing the present invention to great advantage, may adapt it to tower cranes, derricks, rail cranes, service cranes, and others. Boom 2 may be a telescoping boom, a lattice boom, a fixed length boom, a multi-sectioned boom, a two-legged boom, or other types of boom. Mast 3 may be massive as in a derrick or counter-boom, it may be telescoping, and it may be a twin column mast or a single column. Other means of coordinating the rotation of the mast and the boom are contemplated. A hydraulic cylinder is a telescoping strut utilizing oil to perform locking and actuating functions. A telescoping or hinged strut with mechanical locking means would be effective to perform the clutch function of the present invention. The characteristics of the clutch contemplated include: (1) the lock between mast and boom must be effective in either direction of rotation, i.e. a strut providing the clutching action must be a push-pull element while a sprag must be lockable in both directions of rotation simultaneously. (2) the lock must be releasable; (3) the lock must be of sufficient strength to obtain advantage.

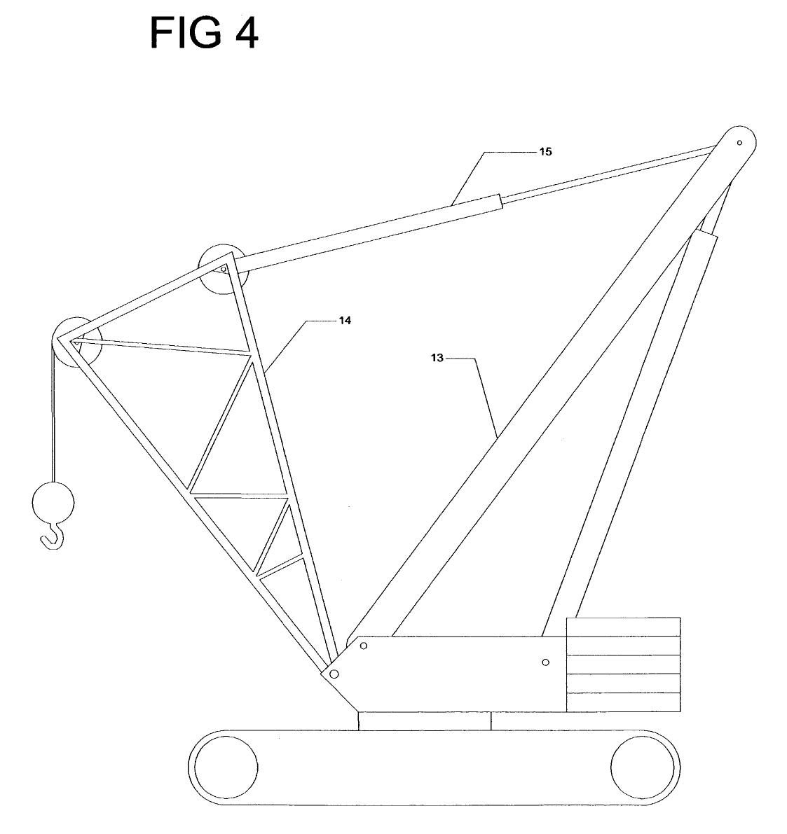

FIG. 4 shows a lattice boom crane pursuant to U.S. Pat. No. 6,062,405. The boom clutch of the present invention includes hydraulic cylinder 15, shown linking boom 14 with live mast 13. In this embodiment, cylinder 15 is a hydraulic cylinder suitable to be loaded in tension and compression. In the self assembly mode shown cylinder 15 is fully extended serving as a pendant to luff boom 14 corresponding with rotation of mast 13. According to the present invention cylinder 15 also serves the function of boom restraint. The piston side of cylinder 15 is connected to a valve arranged to direct pressurized oil from the machine hydraulic pump or from a pressurized gas-filled reservoir. This is a common hydraulic circuit used on hydro-pneumatic suspensions and is not necessary to detail in order for anyone with skill in the art to construct.

The advantage of such a system on this application is that the operator can select modes where he can either: (1) Pressurize the piston side of cylinder 15 from the machine hydraulic pump to extend that cylinder, changing the respective angle between boom 14 and mast 13 for transport or erection duties; (2) Switch valve to close off the pump and open the piston side port to the compressed gas reservoir allowing cushioned restraint to the overluff tendency of boom 14; (3) Pressurize the rod side of cylinder 15 to retract that cylinder, allowing pendant length adjustment while supporting boom 14.

These embodiments of the present invention do not demonstrate all of the advantages of other embodiments, but represent the present invention in forms with their own advantages. The locking function may be cushioned by spring or pressurized gas reservoir.

What I claim is:

1) A crane, with a pendant supported boom rotating in a vertical plane, the pendants operable to rotate said boom by a mast rotating in a vertical plane, means to rotate the mast, and said means to rotate operable to restrain the mast from counter rotation; wherein the improvement being a clutch releaseably coupling said mast to said boom, said clutch operable to restrain rotation of said boom in either direction in the absence of rotation of said mast.

2) A crane, with a pendant supported boom rotating in a vertical plane, the pendants operable to rotate said boom by a mast rotating in a vertical plane, means to rotate the mast, and said means to rotate operable to restrain the mast from counter rotation; wherein the improvement being said clutch releaseably coupling said mast to said boom so that rotational force in either direction upon said boom generates corresponding moment in said mast.

3) The crane of claim 1 and claim 2 and said clutch comprising a telescoping strut with a first end and a second end, said first end connecting to said mast and said second end connecting to said boom, and; said strut comprising a releasable length lock.

4) The crane of claim 1 and claim 2 and said clutch comprising a hinged strut with a first end and a second end, said first end connecting to said mast and said second end connecting to said boom, and; said strut comprising a releasable length lock.

5) The crane of claim 1 and claim 2 said clutch comprising an actuator operative to change the angle of said mast in the vertical plane of rotation with respect to the angle of said boom in said vertical plane.

6) A crane, with a pendant supported boom rotating in a vertical plane, the pendants operable to rotate said boom by a mast rotating in a vertical plane, means to rotate said mast, said rotating means operable to restrain said mast from counter rotation, and said boom a telescoping boom; wherein the improvement being a clutch releaseably coupling said mast to said boom, said clutch operable to restrain respective rotation between said mast and said boom.

7) The crane of claim 6 wherein said clutch comprises an actuator operative to forcibly change the angle of said mast in the vertical plane of rotation with respect to the angle of said boom in said vertical plane.

8) The crane of claims 1, 2, 3, 4, and 5 comprising a telescoping boom.

9) The crane of claims 1, 2, 3, 4, 5, and 8 comprising an extensible pendant.

10) The crane of claim 1 and said restraint variable.
